(19) United States
(12) Patent Application Publication
(10) Pub. No.: US 2009/0246411 A1
(43) Pub. Date: Oct. 1, 2009

(54) SYSTEM AND METHOD OF SEALING SEAMS OF HEATING AND COOLING PRODUCTS

(76) Inventor: Jarrod FENTON, Bellville, OH (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 12/054,885

(22) Filed: Mar. 25, 2008

(51) Int. Cl. H05B 6/00; B05C 9/08

(52) U.S. Cl. 427/595; 118/620

(57) ABSTRACT

A system and method of sealing heating and cooling products includes an ultraviolet-curing sealant and an ultraviolet light. A material used to make a heating and cooling product is moved using a transport system. The sealant is dispensed from a sealant supply using a dispenser onto the material. The ultraviolet-curing sealant is dispensed onto a portion of the material that forms a seam. The ultraviolet-curing sealant is exposed to an ultraviolet light that cures the sealant. The material or the ultraviolet light is moved to expose the sealant to the ultraviolet light. The ultraviolet-curing sealant may be an ultraviolet-curing adhesive.

### FIELD OF THE INVENTION

The invention relates generally to sealing heating and cooling products. More particularly, the invention relates to sealing seams of heating and cooling products with a sealer that is cured using ultraviolet light.

### BACKGROUND OF THE INVENTION

Products used in heating/ventilation/air conditioning (HVAC) units are typically formed of steel. In particular, duct work for HVAC units is typically made from one or more sections of steel. The sections of steel are joined to create the duct work. Seams are created where the sections of steel are joined resulting in steel against steel. These seams result in inefficiency of the HVAC unit as a result of the loss of heated or cooled air escaping the duct work through the seams.

Numerous attempts have been made to address this inefficiency. For example, tapes have been applied over the seams to reduce the loss of heated or cooled air through the seam. Tapes reduce a portion of the heated or cooled air that escapes through the seam, however, inefficiencies in the HVAC unit still result. Mastics have also been used to fill a portion of the seam to reduce an amount of heated or cooled air escaping through the seam. Additionally, applying tapes and mastics to HVAC products is labor intensive and often involves hours of cure time.

Another method of sealing HVAC products uses a butyl (rubber) gasket. The gasket is injected or taped into the seam of the product to reduce the loss of heated or cooled air through the seam. Butyl, however, has several disadvantages. For example, butyl takes a long time to cure, breaks down over time, and requires replacement.

These and other disadvantages exist with current systems.

### SUMMARY OF THE INVENTION

The foregoing disadvantages are overcome, to a great extent, by the invention, wherein in one aspect a method of sealing seams of heating and cooling products is provided that in some embodiments uses an ultraviolet light to cure an ultraviolet-light sealant. A material used to make a heating and cooling product is moved using a transport system. The sealant is dispensed from a sealant supply using a dispenser onto the material. The ultraviolet-curing sealant is dispensed onto a portion of the material that forms a seam. The ultraviolet-curing sealant is exposed to an ultraviolet light that cures the sealant. The material or the ultraviolet light is moved to expose the sealant to the ultraviolet light. The ultraviolet-curing sealant may be an ultraviolet-curing adhesive.

In accordance with one embodiment of the invention, a system of sealing seams of heating and cooling products is provided that includes a supply of material used to form the heating and cooling products. The material is transported to a dispensing station using a transport system. The dispensing station dispenses sealant from a sealant supply onto a portion of the material that forms a seam. The sealant is cured using ultraviolet light to create a substantially air-tight seal. The material may be transported to a material handler using the transport system to, for example, form the product or perform other process.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a block diagram of a system of sealing a seam of a heating and cooling product according to one embodiment of the invention.

FIG. 2 is a block diagram of a method of sealing a seam of a heating and cooling product according to one embodiment of the invention.

FIG. 3 is a top perspective view of a heating and cooling product that includes an ultraviolet-curing sealant.

### DETAILED DESCRIPTION

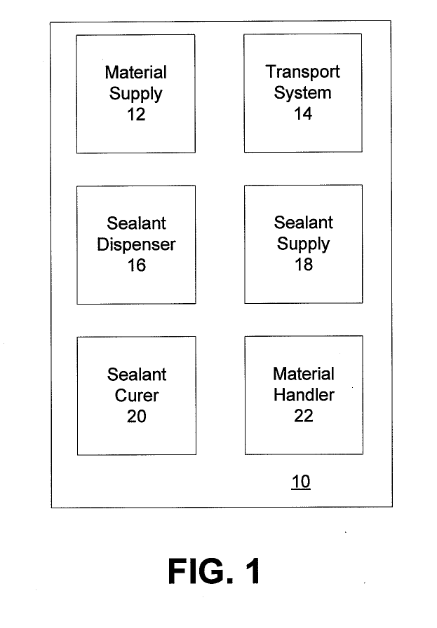

The invention will now be described with reference to the drawing figures, in which like reference numerals refer to like parts throughout. One embodiment in accordance with the invention provides a system 10 of sealing a seam of a heating and cooling product as illustrated in FIG. 1. The system 10 includes a material supply 12, transport system 14, sealant dispenser 16, sealant supply 18, sealant curer 20, and material handler 22.

According to one embodiment of the invention, the material supply 12 may be operatively connected to the transport system 14 such that the material supply 12 is automatically provided on the transport system 14 which then transports the material supply 12 to other portions of the system 10 for processing (described in further detail below).

For example, the material supply 12 may include a roll of steel, aluminum or other material that is used to manufacture, for example, heating and cooling products such as ducts, pipes, fittings, etc. The roll may be placed on a roll dispenser that, either manually or automatically, causes a portion of the material supply 12 to be unwound from the roll and placed on the transport system 14. This portion of the material supply 12 may be moved past, for example, a cutting device that may be used to cut the material supply 12 to a desired length. The cutting device may cut the material supply 12 to the desired length and the material supply 12 may be moved and processed through the system 10 using the transport system 14.

According to another embodiment of the invention, the material supply 12 may be manually provided or placed on the transport system 14. For example, a portion of the material supply 12 that may be in a form of a heating and cooling or other product may be manually placed on the transport system 14. The portion of the material supply 12 may be treated with a sealant (described in further detail below) prior to being placed on the transport system 14. The sealant may then be processed as it passes through the system 10 using the transport system 14.

According to another embodiment of the invention, the material supply 12 may be placed on a stationary, but preferably movable support such as a workbench, table, etc. The material supply 12 may then be processed by the system 10 by, for example, providing a sealant thereon and subjecting the sealant to the sealant curer 20 as described in further detail below.

The transport system 14 may be used to transport the material supply 12 throughout the system 10. Upon receiving the material supply 12, the transport system 14 may transport the material supply 12 to the sealant dispenser 16. The sealant dispenser 16 may be used to dispense a sealant from the sealant supply 18 onto the material supply 12. The sealant may be used to seal a seam of, for example, a heating and cooling product such as a duct, pipe, fitting, etc.

According to one embodiment of the invention, the sealant may be an ultraviolet-curing adhesive, for example, urethane acrylate, such as the EMAX 10070 gasket manufactured by Dymax® Corporation. The sealant may be placed on, for example, an already formed seam of the product, a portion of the material supply 12 that is to be used to form a seam or other desired location. The sealant may be exposed to ultraviolet light that cures the sealant in a short period of time.

According to one embodiment of the invention, the sealant may include a pigment. The pigment may be used to dye the sealant a desired color. For example, the pigment may be a red pigment so that the sealant may be more readily identifiable on a heating/ventilation/air-conditioning (HVAC) or other product.

Use of an ultraviolet-curing adhesive also increases an efficiency of a system that uses the product. For example, the sealant may be provided in a seam of a duct used in HVAC systems. As discussed above, prior systems use sealants that do not provide substantially air-tight seals, use materials that break-down over time and require replacement or require extended curing times. An ultraviolet-curing adhesive provides a substantially air-tight seal that requires little curing time and assists in maintaining an integrity of a seam by adhering two or more parts.

The sealant dispenser 16 may be, for example, a manually-operated spray nozzle that injects the sealant into a female lock of a seam of, for example, a heating and cooling product. The sealant supply 18 may be stored in, for example, a pressurized container that uses a hydraulic accumulator. The sealant may be extracted from the container automatically or manually using, for example, a foot-operated or other device. The sealant may be injected into the seam through a fine-tip or other injection spray nozzle. Various nozzles may be used depending on a desired bead size for the sealant to be placed in the seam.

According to one embodiment of the invention, the sealant dispenser 16 may be an automated dispenser that automatically dispenses the sealant supply 18 onto the material supply 12. The sealant dispenser 16 may be a stationary dispenser that is provided in a location of the system 10 where the material supply 12 passes such that as the material supply 12 passes the sealant dispenser 16, sealant may be dispensed onto the material supply 12. According to another embodiment of the invention, the sealant dispenser 16 may be movable such that the material supply 12 may remain stationary while the sealant dispenser 16 is passed over the material supply 12 to dispense the sealant onto a desired location of the material supply 12.

Sealant provided on a seam or other portion of a product may be subjected to the sealant curer 20 to cure the sealant. According to one embodiment of the invention, the sealant curer 20 includes an ultraviolet lamp. The ultraviolet lamp may be, for example, a four-hundred watt ultraviolet lamp. The sealant on the product may be exposed to ultraviolet light from the ultraviolet lamp to cure the sealant. As stated above, the sealant is cured soon after being exposed to the ultraviolet light.

According to one embodiment of the invention, the sealant curer 20 is stationary. The transport system 14 is used to pass the material supply 12 having the sealant by sealant curer 20 such that the sealant is exposed to the sealant curer 20. According to another embodiment of the invention, the sealant curer 20 is movable. In this manner, the material supply 12 may be stationary and the sealant curer 20 is passed over the material supply 12 that includes the sealant thus exposing the sealant to the sealant curer 20.

According to one embodiment of the invention, the sealant dispenser 16 and the sealant curer 20 may be combined into a single movable device. For example, the sealant dispenser 16 and the sealant curer 20 may be provided adjacent each other and the device may be mounted on a track. The device moves along, back-and-forth or in another manner on the track. The device may be formed such that as the device moves on the track, the sealant is dispensed in front of the sealant curer 20. In this manner, the sealant curer 20 cures the sealant as the sealant is placed on the material supply 12. The sealant may be dispensed in multiple directions on the track, the sealant curer 20 may be operating in one or more directions on the track, the material supply 12 may be moved before, while, and/or after the device is in motion. Other scenarios may also be used.

After providing sealant on the material supply 12 and curing the sealant, the material supply may be subjected to the material handler 22. The material handler 22 may be, for example, a duct or pipe shaping device. For example, the material handler 22 may process the material supply 22 by rolling the material supply 12 into a desired shape having a desired diameter and forming grooves in one or both ends of the duct or pipe to facilitate insertion of the duct or pipe into a fitting or other HVAC product. Other types of or no material handler 22 may be used, required or desired.

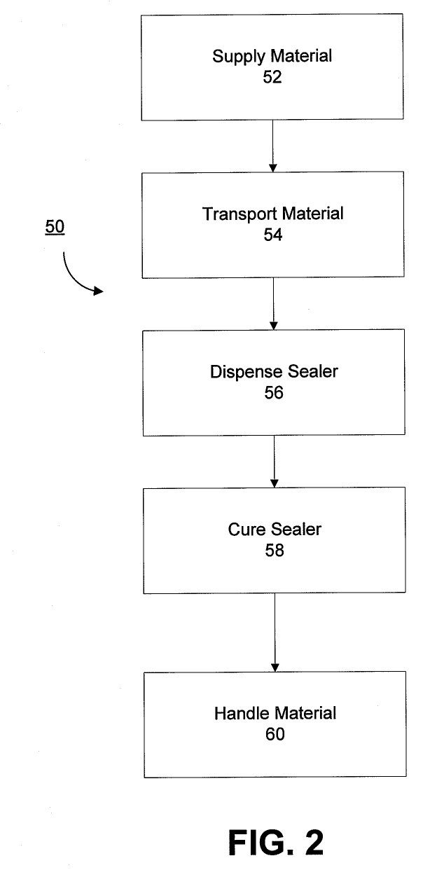

FIG. 2 illustrates a method 50 of sealing a seam of a HVAC product according to one embodiment of the invention. The method 50 includes supplying a material to be used for forming the HVAC product, step 52. The material may be supplied from, for example, a roll of material, manually or other method as discussed above or known to one of ordinary skill in the art. The material may be transported to one or more stations or locations within a system that forms the HVAC product, step 54. The material may be transported using, for example, a conveyor or other known system for transporting materials.

The transport system may transport the material to, for example, a dispensing station where a sealer is dispensed onto the material, step 56. The sealant may be dispensed onto a seam of the product (if the material is already formed into the product), a portion of the material that is to be used to form a seam for the product or other desired location. The sealant may be dispensed using a fine-tip spray nozzle or other dispenser as discussed above or as known to one or ordinary skill in the art.

The transport system may then transport the material to, for example, a curing station, where the sealant dispensed onto the material in step 56 is cured, step 58. As discussed above, the sealant may be an ultraviolet-curing adhesive. In this embodiment, the curing station includes one or more ultraviolet lamps, which may be, for example, three-hundred watt ultraviolet lamps. The material having the ultraviolet-curing adhesive dispensed thereon is exposed to ultraviolet light from the ultraviolet lamps. The ultraviolet light from the lamps cures the ultraviolet-curing adhesive shortly after being exposed to the lamps.

After curing the sealant in step 58, the material may be transported to a handling station where a material handler processes the material, step 60. For example, material that is being used to form a HVAC product may be transported to a material handler that shapes the material as discussed above. Other types of material handling may also be performed.

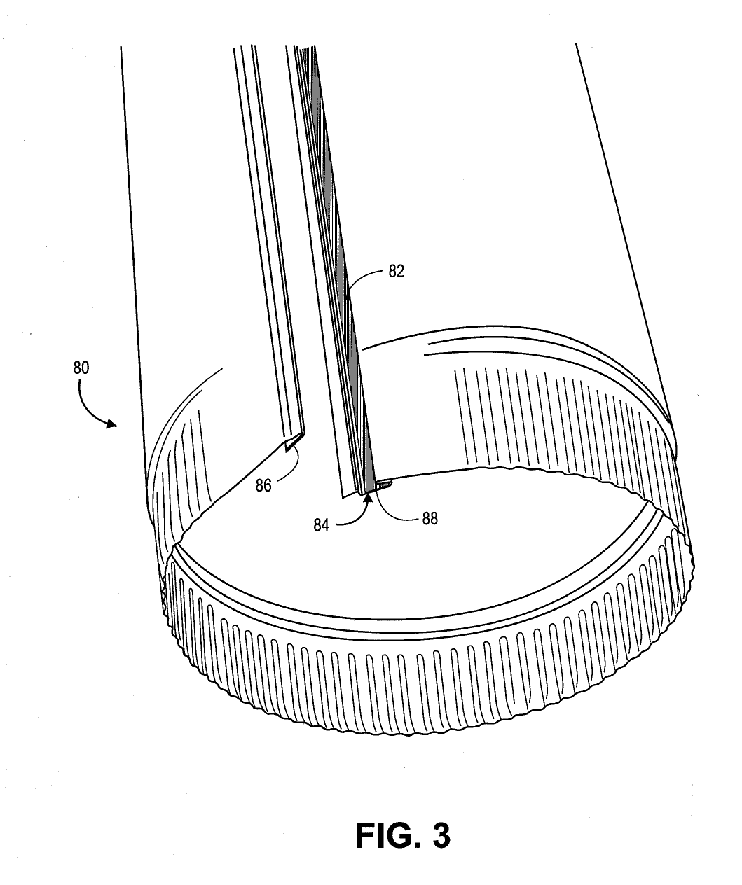

FIG. 3 illustrates a HVAC product 80 having an ultraviolet-curing adhesive 82 according to one embodiment of the invention. The HVAC product 80 has a seam 84 that includes a male portion 86 and a female portion 88. The male portion 86 and the female portion 88 lock to maintain the HVAC product 80 in a desired shape. The ultraviolet-curing adhesive 82 is provided in the female portion 88 of the seam 84. The ultraviolet-curing adhesive 82 may be dispensed into the female portion 88 of the seam 84 before or after the HVAC product 80 has been shaped.

After being dispensed into the female portion 88 of the seam 84, the ultraviolet-curing adhesive 82 may be cured using ultraviolet lamps using system of sealing heating and cooling products as described above. After curing, the male portion 86 is inserted into the female portion 88 to seal the seam 84 of the HVAC product 80. The ultraviolet-curing adhesive 82 provides additional sealing properties to the seam 84 to create a substantially air-tight seal between the male portion 86 and the female portion 88.

According to one embodiment of the invention, the ultraviolet-curing adhesive 82 is dispensed onto the seam 84 of the HVAC product 80 after or before and after the HVAC product 80 has been shaped. In this manner, a tighter seal may be provided along the seam 84 of the HVAC product 80.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A method of sealing seams of heating and cooling products, comprising:
applying an ultraviolet-curing sealant to a portion of a material that is used to form a seal of a heating and cooling product; and
curing the sealant using ultraviolet light.

2. The method of claim 1, further comprising dispensing the ultraviolet-curing sealant.

3. The method of claim 1, further comprising a transporting the material.

4. The method of claim 1, wherein the ultraviolet-curing sealant comprises an ultraviolet-curing adhesive.

5. The method of claim 1, wherein the ultraviolet-curing sealant and the ultraviolet light are moved relative to each other.

6. The method of claim 1, wherein the ultraviolet-curing sealant is moved relative to the ultraviolet light.

7. The method of claim 1, wherein the ultraviolet light is moved relative to the ultraviolet-curing sealant.

8. The method of claim 1, wherein the ultraviolet-curing sealant comprises a pigment.

9. The method of claim 1, wherein the heating and cooling product comprises any one of a duct, pipe, and fitting.

10. The method of claim 1, wherein the ultraviolet-curing sealant comprises urethane acrylate.

11. A system of sealing seams of heating and cooling products, comprising:
a supply of material used to form a heating and cooling product;
a transport system configured to transport the material;
an ultraviolet-curing sealant supply;
a sealant dispenser configured to dispense at least a portion of the ultraviolet-curing sealant supply onto the material; and
a sealant curer configured to cure the ultraviolet-curing sealant supply dispensed onto the material using ultraviolet light.

12. The system of claim 11, further comprising a material handler configured to handle the material.

13. The system of claim 12, wherein the material handler uses the material to form a heating and cooling product.

14. The system of claim 11, wherein the ultraviolet-curing sealant comprises an ultraviolet-curing adhesive.

15. The system of claim 11, wherein the portion of the sealant supply and the material move relative to each other.

16. The system of claim 11, wherein the portion of the sealant supply moves relative to the material.

17. The system of claim 11, wherein the material moves relative to the portion of the sealant supply.

18. The system of claim 11, wherein the sealant supply comprises urethane acrylate.

19. The system of claim 11, wherein the sealant comprises a pigment.

20. The system of claim 11, wherein the heating and cooling product comprises any one of a duct, pipe, and fitting.
